(19) United States
(12) Patent Application Publication
(10) Pub. No.: US 2013/0300308 A1
(43) Pub. Date: Nov. 14, 2013

(54) Current Limiting LED Driver

(71) Applicant: Laurence P. Sadwick, Salt Lake City, UT (US)

(72) Inventor: Laurence P. Sadwick, Salt Lake City, UT (US)

(21) Appl. No.: 13/892,586

(22) Filed: May 13, 2013

Related U.S. Application Data
(60) Provisional application No. 61/646,289, filed on May 12, 2012.

(51) Int. Cl. H05B 33/08

(52) U.S. Cl. CPC H05B 33/089
USPC 315/224

(57) ABSTRACT

An LED driver with current limiter.

### BACKGROUND

Electricity is generated and distributed in alternating current (AC) form, wherein the voltage varies sinusoidally between a positive and a negative value. However, many electrical devices require a direct current (DC) supply of electricity having a constant voltage level, or at least a supply that remains positive even if the level is allowed to vary to some extent. For example, light emitting diodes (LEDs) and similar devices such as organic light emitting diodes (OLEDs) are being increasingly considered for use as light sources in residential, commercial and municipal applications. However, in general, unlike incandescent light sources, LEDs and OLEDs cannot be powered directly from an AC power supply unless, for example, the LEDs are configured in some back to back formation. Electrical current flows through an individual LED easily in only one direction, and if a negative voltage which exceeds the reverse breakdown voltage of the LED is applied, the LED can be damaged or destroyed. Furthermore, the standard, nominal residential voltage level is typically something like 120 V or 240 V, both of which are often higher than may be desired for a high efficiency LED light. Some conversion of the available power may therefore be necessary or highly desired with loads such as an LED light.

Drivers or power supplies for loads such as an LED may be configured to provide a desired load current based on the expected line voltage. However, for example, in input overvoltage conditions, the load condition may rise unacceptably and damage the load.

### SUMMARY

A current limiting LED driver is disclosed that limits current to a load during, for example, input overvoltage conditions, protecting the load. An overvoltage detector in the current limiting LED driver detects input overvoltage conditions and limits the load current. For example, in some embodiments of the current limiting LED driver, a variable pulse generator controls a main input power switch to adjust the load current. The pulse width of the variable pulse generator is set to a constant value during normal operation to provide the desired load current based on expected input voltage conditions. For example, the variable pulse generator may include a DC voltage to pulse width converter, with a current source and resistor combination providing the DC reference voltage to set the pulse width. During input overvoltage conditions, the overvoltage detector changes, as an example, the resistance connected to the current source, reducing the DC reference voltage and causing the pulse width from the variable pulse generator to be reduced, limiting load current. The present invention is not limited to the example above and applies and can be applied to both isolated and non-isolated power supplies and drivers in general including LED power supplies and drivers. Although current limiting example embodiments are presented herein, the present invention can also be used for voltage and or power limiting. The embodiments shown and discussed are intended to be examples of the present invention and in no way or form should these examples be viewed as being limiting of and for the present invention.

This summary provides only a general outline of some particular embodiments. Many other objects, features, advantages and other embodiments will become more fully apparent from the following detailed description.

### BRIEF DESCRIPTION OF THE DRAWINGS

A further understanding of the various embodiments may be realized by reference to the figures which are described in remaining portions of the specification. In the figures, like reference numerals may be used throughout several drawings to refer to similar components.

FIG. 1 depicts a block diagram of an LED driver with a current limiter in accordance with some embodiments of the invention;

FIG. 2 depicts a schematic of an LED driver with a current limiter in accordance with some embodiments of the invention;

FIG. 3 depicts a schematic of an LED driver with a current limiter in accordance with some embodiments of the invention;

FIG. 4 depicts a schematic of a current limiter with a tag-along inductor in accordance with some embodiments of the invention;

FIG. 5 depicts a schematic of a current limiter with a tag-along inductor in accordance with some embodiments of the invention;

FIG. 6 depicts a schematic of a current limiter with a tag-along inductor in accordance with some embodiments of the invention;

FIG. 7 depicts a schematic of a current limiter having a difference amplifier and a gain stage in accordance with some embodiments of the invention;

FIG. 8 depicts a schematic of a current limiter having a time constant, a difference amplifier and a gain stage in accordance with some embodiments of the invention;

FIG. 9 depicts a schematic of a current limiter having an error amplifier or difference amplifier or comparator with a reference voltage in accordance with some embodiments of the invention;

FIG. 10 depicts a schematic of a current limiter having an error amplifier or difference amplifier or comparator with a time constant and a reference voltage in accordance with some embodiments of the invention;

FIG. 11 depicts a schematic of a current limiter having a difference amplifier that may have a non-unity gain with a reference voltage in accordance with some embodiments of the invention;

FIG. 12 depicts a schematic of a current limiter having an error amplifier or difference amplifier or comparator with a reference voltage using a field effect transistor in accordance with some embodiments of the invention;

FIG. 13 depicts a schematic of a current limiter having a difference amplifier that may have a non-unity gain with a reference voltage using a field effect transistor in accordance with some embodiments of the invention;

FIG. 14 depicts a schematic of a current limiter having two error amplifiers or difference amplifiers or comparators with a reference voltage in accordance with some embodiments of the invention; and

FIG. 15 depicts a schematic of a current limiter having three error amplifiers or difference amplifiers or comparators with a reference voltage in accordance with some embodiments of the invention.

### DESCRIPTION

A current limiting LED driver, which can also be used for applications and purposes and power supplies and drivers other than LED drivers, is disclosed that, for example, limits current to a load during input overvoltage conditions, protecting the load. An overvoltage detector in the current limiting LED driver detects input overvoltage conditions and limits the load current. For example, in some embodiments of the current limiting LED driver, a variable pulse generator controls a main input power switch to adjust the load current. The pulse width of the variable pulse generator is set to a constant value during normal operation to provide the desired load current based on expected input voltage conditions. For example, the variable pulse generator may include a DC voltage to pulse width converter, with a current source and resistor combination providing the DC reference voltage to set the pulse width. During input overvoltage conditions, the overvoltage detector changes the resistance connected to the current source, reducing the DC reference voltage and causing the pulse width from the variable pulse generator to be reduced, limiting load current. The present invention may also be used to produce various peaks and plateaus in the load current at useful input voltage ranges such as 80 to 130 VAC, 100 to 120 VAC, 200 to 240 VAC, 240 VAC to 305 VAC, 80 to 240 VAC, 100 to 305 VAC, etc. The present invention may also provide high power factor.

Examples of LED drivers that may incorporate a current limiter disclosed herein include those in U.S. patent application Ser. No. 13/404,514, filed Feb. 24, 2012 for a “Dimmable Power Supply”, in U.S. patent application Ser. No. 12/776,409, filed May 9, 2010 for a “LED Lamp with Remote Control”, in U.S. Patent Application 61/558,512 filed Nov. 11, 2011 for a “Current Limiting LED Driver”, and in U.S. patent application Ser. No. 13/299,912 filed Nov. 18, 2011 for a “Dimmable Timer-Based LED Power Supply” which are all incorporated herein by reference for all purposes. Such a driver provides power for lights such as LEDs of any type including inorganic and organic LEDs (OLEDs) and other loads. References to LEDs in this document in general refer to all types of LEDs including OLEDs.

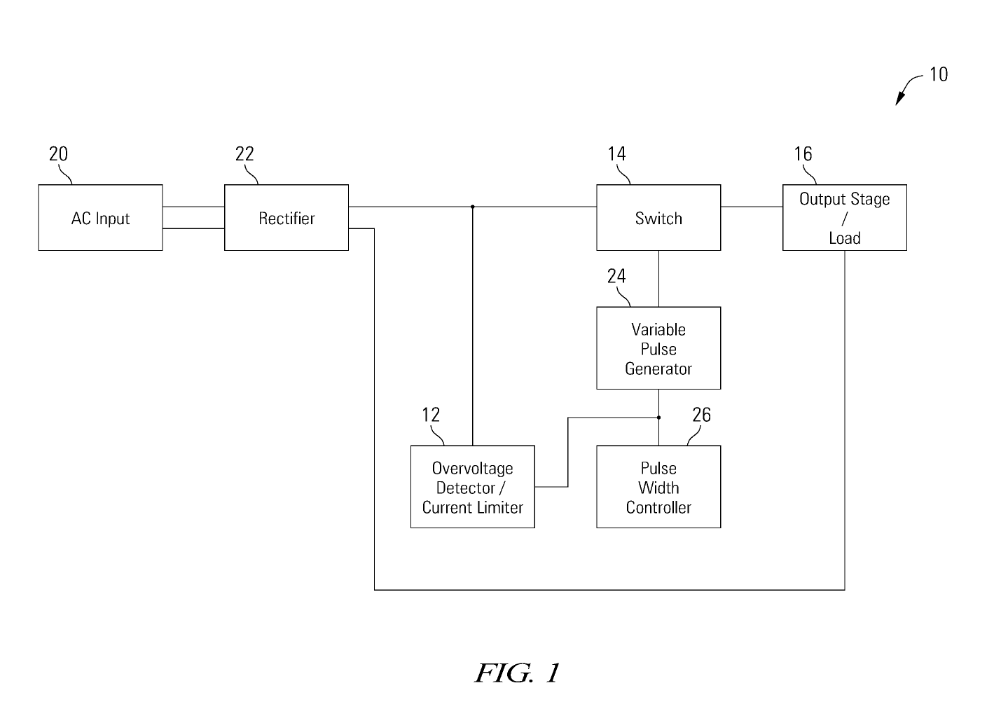

Turning to FIG. 1, a block diagram of an LED driver 10 is depicted as an example application of a current limiter 12 in accordance with some embodiments of the invention. A switch 14 controls current through an output stage and load 16, drawing power for example from an AC input 20 through a rectifier 22, or, in other embodiments, from a DC source. A variable pulse generator 24 provides a series of control pulses to the switch 14, setting the current through the load 16 to a desired level based on the expected input voltage from AC input 20 (or from any other voltage input). In some embodiments, the variable pulse generator 24 produces pulses at a much higher frequency than that at the AC input 20.

A pulse width controller 26 sets the pulse width and/or frequency from the variable pulse generator 24. An overvoltage detector and current limiter 12 overrides the pulse width controller 26 or otherwise acts to reduce the pulse width or turn off the pulses from the variable pulse generator 24 if the input voltage exceeds that expected or reaches a level that would damage the load 16 or other components.

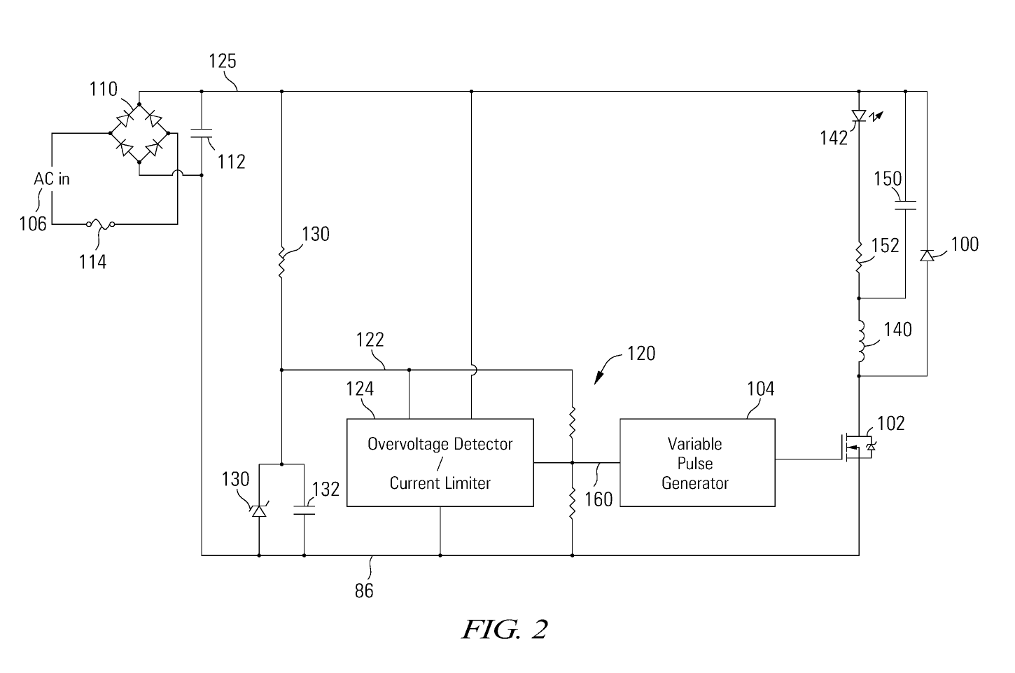

Turning to FIG. 2, a schematic of an example LED driver with a current limiter is depicted in accordance with some embodiments of the invention. A dimmable constant current is supplied to the load 100, regulated by a switch such as a transistor 102, under the control of a variable pulse generator 104. The transistor 102 may be any suitable type of transistor or other device, such as a bipolar transistor or field effect transistor of any type and material including but not limited to metal oxide semiconductor FET (MOSFET), junction FET (JFET), bipolar junction transistor (BJT), heterojunction bipolar transistor (HBT), insulated gate bipolar transistor (IGBT), etc, and can be made of any suitable material including but not limited to silicon, gallium arsenide, gallium nitride, silicon carbide, etc which has a suitably high voltage rating. An AC input 106 is rectified in a rectifier 110 such as a diode bridge and may be conditioned using a capacitor 112. An electromagnetic interference (EMI) filter (not shown) may be connected to the AC input 14 to reduce interference, and a fuse 114 or similar device or devices may be used to protect the driver and wiring from excessive current due to short circuits or other fault conditions.

The variable pulse generator 104 generates pulses that turn the transistor 102 on and off, with the on-time of the pulses or pulse width controlled by a voltage divider 120, referenced to a bias supply 122.

The bias supply 122 may be used to power internal components as well, such as the variable pulse generator 104 and an overvoltage detector/current limiter 124. The bias supply 122 may be set at any suitable voltage level relative to the DC input 125, and may be generated by any suitable device or circuit. For example, a resistor 126 in series with a Zener diode 130 and capacitor 132 may be used, optionally in combination with other components, to generate the bias supply 122 based on the DC input 125 or other voltage or current source.

An inductor 140 and the load 142 are connected in series with the switch 102, and a diode 100 is connected in parallel with the inductor 140 and the load 142. When the transistor 102 is turned on or closed, current flows from the rectified DC input 125 through the load 142 and energy is stored in the inductor 140. When the transistor 102 is turned off, energy stored in the inductor 140 is released through the load 142, with the diode 100 forming a return path for the current through the load 142 and inductor 140. The inductor 140, load 142 and diode 100 thus form a load loop in which current continues to flow briefly when the transistor 102 is off. In some embodiments, the load loop is placed above the switch 102, in other embodiments, the load loop is placed below the switch 102. Other optional components such as capacitors (e.g., 150) and resistors (e.g., 152) may be included in the driver for various purposes.

Again, the voltage divider 120 sets the pulse width from the variable pulse generator 104 as needed to produce the desired load current when the DC input 125 is at the expected normal voltage level. When the voltage at the DC input 125 rises, for example during transients, if connected to an incorrect AC input 106, or due to any other overvoltage conditions, the voltage at the bias supply 122 will rise, causing the overvoltage detector/current limiter 124 to lower the voltage at a control node 160 to reduce the pulse width from the variable pulse generator 104.

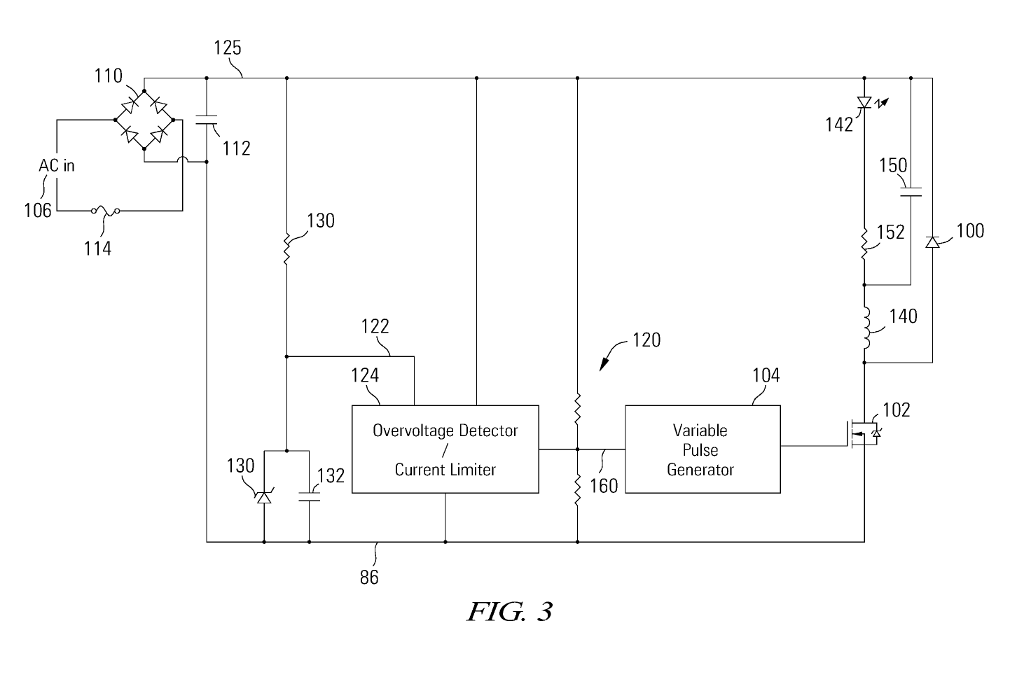

Turning to FIG. 3, a schematic of another example LED driver with a current limiter is depicted in accordance with some embodiments of the invention. In this embodiment, the overvoltage detector/current limiter 124 is referenced to the DC input 125.

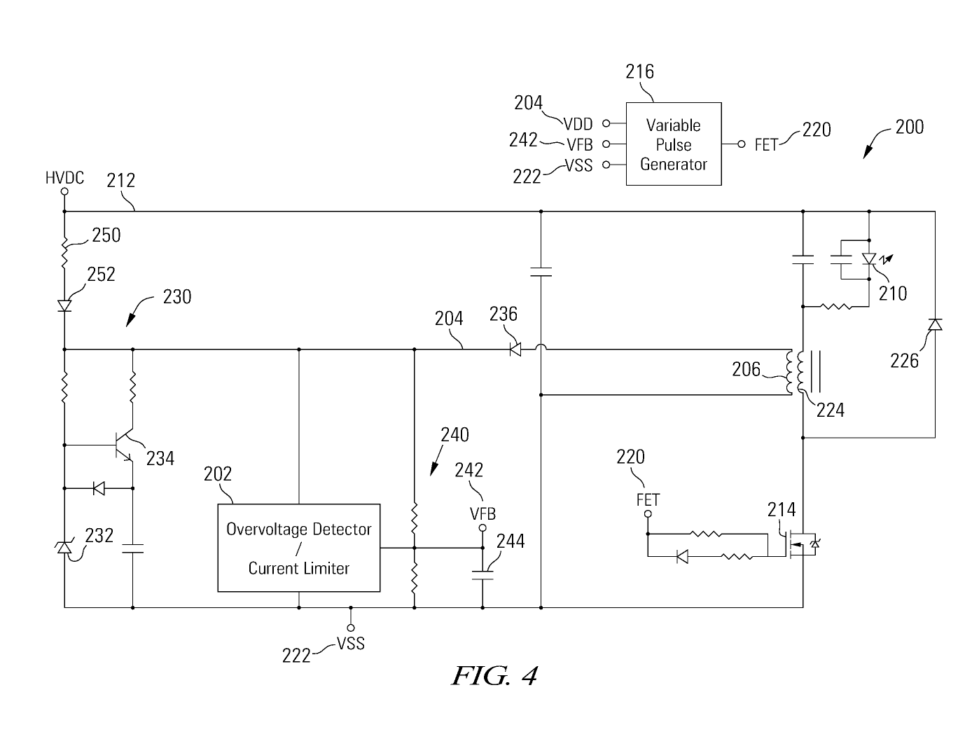

The current limiter can be controlled based on any desired signal representing a circuit condition, such as peak AC voltage. In the embodiment of FIG. 4, the output current is controlled by the bias feedback from a tag-along inductor, which is tied to the current, so if the current increases, the bias voltage increases, providing current control.

Turning to FIG. 4, an LED driver 200 with a current limiter 202 is depicted which generates a bias voltage 204 using a tag-along inductor 206 in accordance with some embodiments of the invention. The LED driver 200 powers and controls a load such as one or more LED lights 210, from a power source such as a DC rail 212, which may be derived from an AC input using a rectifier as disclosed above. A transistor 214 is controlled by a variable pulse generator 216 or other control circuit through a FET control signal 220, blocking or allowing current to flow from the DC rail 212 to a ground 222 through the transistor 214. Again, in this example embodiment, as current flows through the transistor 214, it also flows through a series inductor 224, storing energy in the inductor 224. When the transistor 214 is turned off by the variable pulse generator 216, the inductor 224 releases energy, which circulates through a diode 226 or other secondary path and through the LED 210. One or more optional capacitors may be connected in parallel with the load 210 as shown.

The bias voltage 204 is generated using a bias power source 230, in which current flows from a tag-along inductor 206 wound with inductor 224 to the bias voltage 204. The bias voltage 204 supplied by the power source 230 is set and limited by a Zener diode 232 and voltage regulating transistor 234. A diode 236 restricts current flow from the 206 tag-along inductor 206 to a single direction. A resistor 250 and diode 252 provide power from HVDC 212 to bias voltage node 204 at least during startup, powering the variable pulse generator 216 etc.

A voltage divider 240 generates a feedback signal 242 to set the pulse width from the variable pulse generator 216, setting the load current at the desired level for the expected input voltage at DC rail 212. A capacitor 244 may be connected in parallel with the lower portion of the voltage divider 240, averaging the voltage fluctuations at bias voltage 204 for the feedback signal 242. The current limiting LED driver may include one or more time constants in any suitable location throughout the driver or distributed in multiple locations, and may be embodied in any suitable manner, not to be limited to example RC time constants disclosed herein.

The current limiter 202 monitors the bias voltage 204, and if it rises above a reference voltage in the current limiter 202, it lowers the voltage of feedback signal 242 to reduce the pulse width from variable pulse generator 216. The current limiter 202 thus protects the LED lights 210 from overvoltage conditions that might otherwise damage them. In other embodiments, such an arrangement may be used to produce an essentially constant current over an extended range of either AC or DC input voltages.

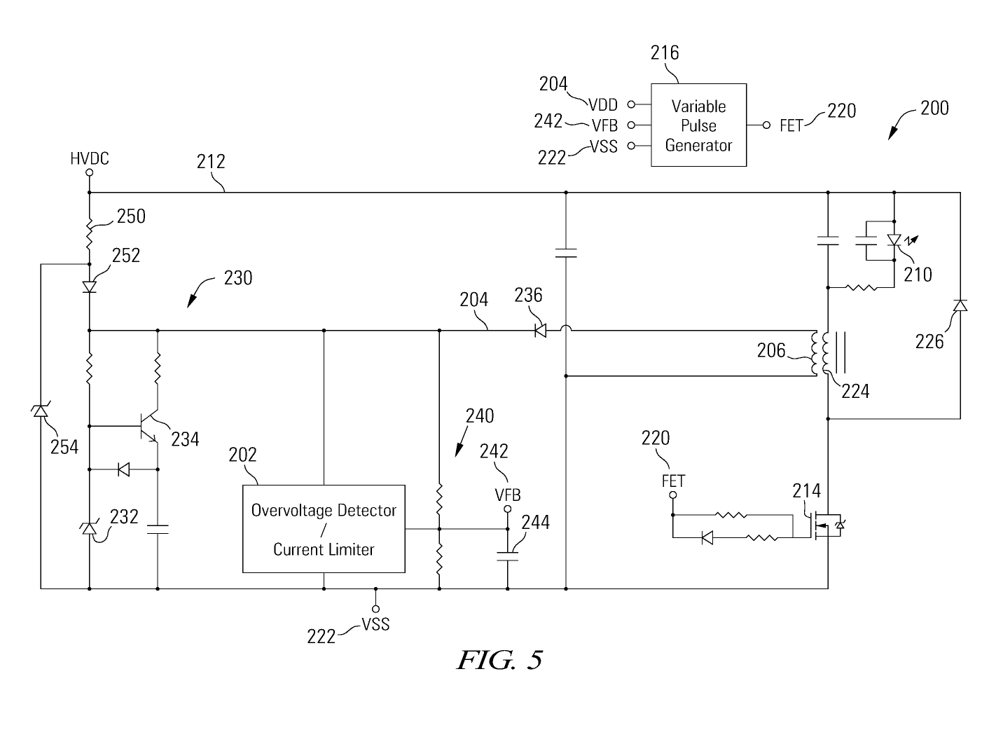

Turning to FIG. 5, an LED driver 200 with a current limiter 202 is depicted which generates a bias voltage 204 using a tag-along inductor 206 in accordance with some embodiments of the invention. In this embodiment, as an example, a Zener diode 254 is included so that resistor 250 and diode 252 initially provide power from HVDC 212 to bias voltage node 204 only during startup, after which bias voltage node 204 is powered by the tag-along inductor 206. In this example embodiment, resistor 250 and diode 252 may also possibly be used, for example, during dimming including deep dimming to low power levels. These embodiments and figures are intended to be examples of the present invention and in no way or form limiting including in terms of the components used to initially turn on/start. The Zener diode voltages of Zener diodes 254 and 232 may be different, with, for example, the Zener diode voltage of 254 being lower than the Zener diode voltage of 232. The above and FIG. 4 are merely an example of an implementation of the present inventions and should not be viewed as limiting in any way or form.

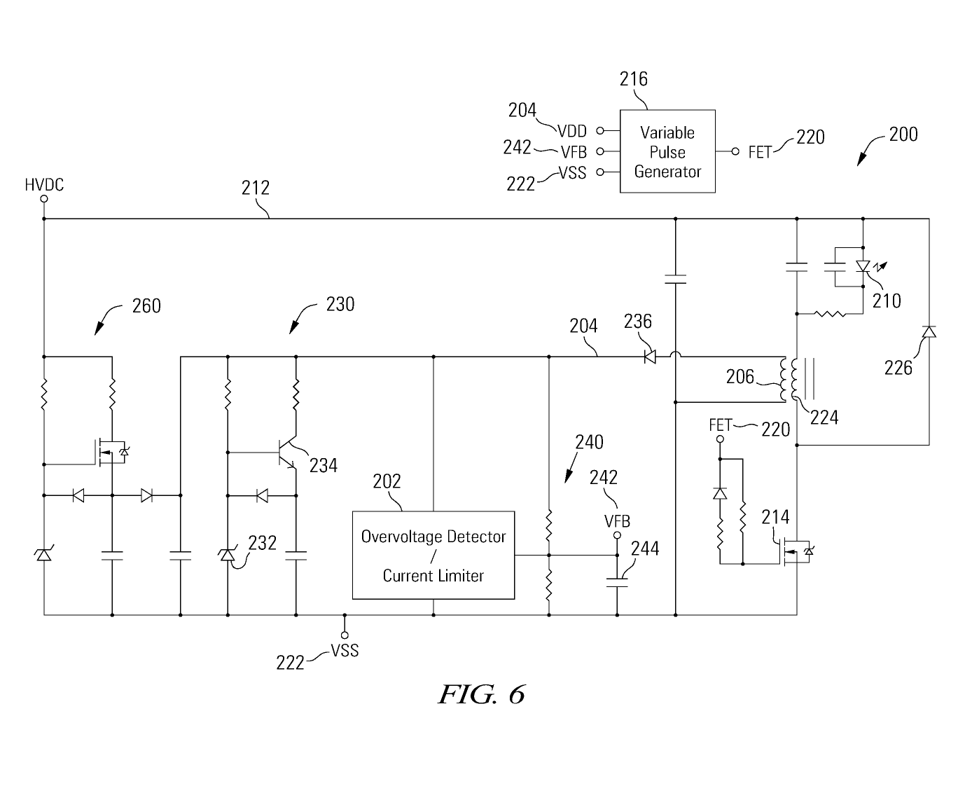

Turning to FIG. 6, another embodiment of the LED driver 200 with a current limiter 202 is depicted, in this case containing another internal power supply 260 which derives power from the DC rail 212 in accordance with some embodiments of the invention.

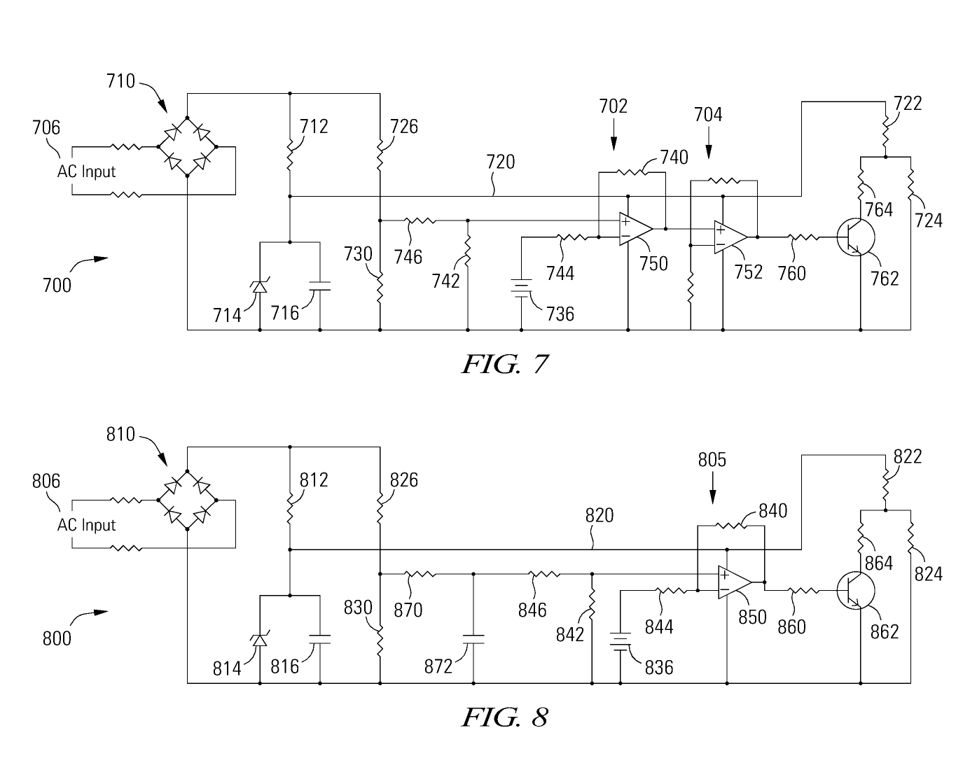

Turning to FIG. 7, a current limiter 700 is depicted having a difference amplifier 702 and a gain stage 704 in accordance with some embodiments of the invention. The AC input 706 illustrated in FIG. 7 may correspond, for example, to AC input 106 of FIG. 2, with full bridge rectifier 710 corresponding to the rectifier 110, resistor 712 to resistor 112, Zener diode 714 to Zener diode 130, and capacitor 716 to capacitor 132, such that the upper voltage rail 720 illustrated in FIG. 7 corresponds with DC supply 125.

Resistors 722 and 724 form a voltage divider corresponding to voltage divider 120, for example, in FIG. 2, used to set the pulse width of variable pulse generator 104.

The current limiter includes a voltage divider with resistors 726 and 730. The difference amplifier 702 compares the voltage from the voltage divider 726, 730 with a reference voltage 736. Difference amplifier 702 includes resistors 740, 742 and 744, 746. If resistors 744 and 746 are the same, and resistors 740 and 742 are the same, then the op-amp 750 yields the difference between the inverting and non-inverting inputs. If resistors 740, 742 are larger than resistors 744, 746 the difference amplifier 702 has a non-unity gain proportional to the ratio between 740, 742 and 744, 746.

The second op-amp 752 provides a gain stage 704. Resistor 760 feeds bipolar transistor 762 to connect resistor 764 in parallel with resistor 724. Resistor 764 may be a smaller value than resistor 724, so that when transistor 762 is turned on, it will reduce the voltage from the voltage divider (e.g., 120) and reduce the pulse width. Although a bipolar junction transistor is depicted, any appropriate device, switch, etc. can be used including MOSFETs, JFETs, other types of FETs, MODFETs, SiC FETs, GaN FETs, high electron mobility transistors (HEMTs), heterojunction bipolar transistors (HBTs), etc.

If transistor 762 is turned on in analog fashion, then the voltage from the voltage divider (e.g., 120) can be reduced gradually or by a small amount. If transistor 762 is turned on in digital fashion, then the voltage from the voltage divider (e.g., 120) can be reduced more drastically to be close to zero, in effect turning off the pulses. This state can exist for as long as the input voltage measured at resistor 746 is higher than at resistor 744. The balance between turning transistor 762 on in analog fashion vs digital fashion can be controlled by the gain of the gain stage 704 or the gain in the difference amplifier 702, or by other means including circuit and/or component changes, etc., if any, and/or by the current and/or voltage fed to other elements and components such as transistors or switches, more complicated circuits, other methods and ways, etc.

Thus, if the input voltage as detected using voltage divider 726, 730 exceeds a reference voltage 744, the higher voltage peaks at the input (e.g., 125) will be clipped (assuming that the variable pulse generator runs at a higher frequency than the AC input frequency), limiting the load current.

FIG. 8 depicts a schematic of a current limiter 800 having a time constant and a combined difference amplifier and gain stage 805 in accordance with some embodiments of the invention. In this embodiment, a time constant is added by resistor 870 and capacitor 872, averaging the signal and operating based on an averaged signal rather than instantaneous peak levels. As soon as the average voltage into the difference amplifier 805 is greater than a setpoint voltage 836, the current limiter 800 turns off the current through the power supply by disabling the pulse generator connected to the current limiter 800.

The AC input 806 illustrated in FIG. 8 may correspond, for example, to AC input 106 of FIG. 2, with full bridge rectifier 810 corresponding to the rectifier 110, resistor 812 to resistor 112, Zener diode 814 to Zener diode 130, and capacitor 816 to capacitor 132, such that the upper voltage rail 820 illustrated in FIG. 8 corresponds with DC supply 125.

Resistors 822 and 824 form a voltage divider corresponding to voltage divider 120, for example, in FIG. 2, used to set the pulse width of variable pulse generator 104.

The current limiter includes a voltage divider with resistors 826 and 830. The difference amplifier 802 compares the voltage from the voltage divider 826, 830 with a reference voltage 836. Difference amplifier 802 includes resistors 840, 842 and 844, 846. If resistors 844 and 846 are the same, and resistors 840 and 842 are the same, then the op-amp 850 yields the difference between the inverting and non-inverting inputs. If resistors 840, 842 are larger than resistors 844, 846 the difference amplifier 802 has a non-unity gain proportional to the ratio between 840, 842 and 844, 846. Op-amp 850 is used as a difference amplifier with gain.

Resistor 860 feeds bipolar transistor 862 to connect resistor 864 in parallel with resistor 824. Resistor 864 may be a smaller value than resistor 824, so that when transistor 862 is turned on, it will reduce the voltage from the voltage divider (e.g., 120) and reduce the pulse width. Although a bipolar junction transistor is depicted, any appropriate device, switch, etc. can be used including MOSFETs, JFETs, other types of FETs, MODFETs, SiC FETs, GaN FETs, high electron mobility transistors (HEMTs), heterojunction bipolar transistors (HBTs), etc.

Transistor 862 can be turned on in analog fashion or in digital fashion, as disclosed above with respect to the current limiter 700 of FIG. 7.

If the input voltage as detected using voltage divider 826, 830 exceeds a reference voltage 844, the higher voltage peaks at the input (e.g., 125) will be clipped (assuming that the variable pulse generator runs at a higher frequency than the AC input frequency), limiting the load current.

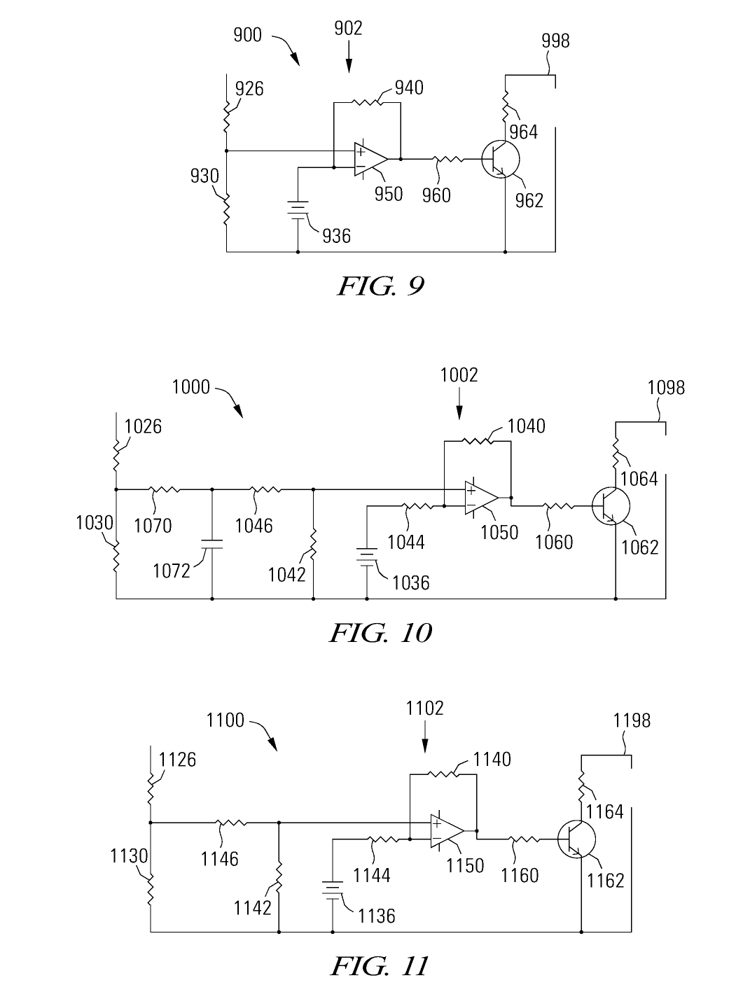

FIG. 9 depicts a schematic of a portion of a current limiter 900 having an error amplifier 902 or difference amplifier or comparator with a reference voltage 936 in accordance with some embodiments of the invention. The current limiter of FIG. 9 may include non-unity gain or not as desired. Power supply components may be included but are not shown, such as an AC input, rectifier, and components such as the resistor 712, Zener diode 714 and capacitor 716 of FIG. 7, to which an input of a voltage divider made up of resistors 926 and 930 is connected. The output of the voltage divider of resistors 926 and 930 is connected to amplifier 950, providing the input power monitor to be compared with reference voltage 936. Feedback resistor 940 is selected to provide the desired response from amplifier 950. Resistor 960 feeds bipolar transistor 962 to connect resistor 964 at output 998 in parallel with a control resistor for a pulse generator circuit, such as the lower resistor in voltage divider 120 of FIG. 2, which operates in conjunction with the upper voltage divider resistor to control the pulse generator to set the pulse width and/or frequency or other characteristics. Resistor 964 may be a smaller value than that resistor, so that when transistor 962 is turned on, it will reduce the voltage from the voltage divider (e.g., 120) and reduce the pulse width. Although a bipolar junction transistor is depicted, any appropriate device, switch, etc. can be used including MOSFETs, JFETs, other types of FETs, MODFETs, SiC FETs, GaN FETs, high electron mobility transistors (HEMTs), heterojunction bipolar transistors (HBTs), etc.

FIG. 10 depicts a schematic of a current limiter 1000 having an error amplifier 1002 or difference amplifier or comparator with a time constant and a reference voltage 1036 in accordance with some embodiments of the invention. A time constant such as that made up of resistor 1070 and capacitor 1072 may be included in any desired location in the current limiter 1000. Power supply components may be included but are not shown, such as an AC input, rectifier, and components such as the resistor 712, Zener diode 714 and capacitor 716 of FIG. 7, to which an input of a voltage divider made up of resistors 1026 and 1030 is connected.

The amplifier 1002 compares the voltage from the voltage divider 1026, 1030 with a reference voltage 1036. Amplifier 1002 includes resistors 1040, 1042 and 1044, 1046. If resistors 1044 and 1046 are the same, and resistors 1040 and 1042 are the same, then the op-amp 1050 yields the difference between the inverting and non-inverting inputs. If resistors 1040, 1042 are larger than resistors 1044, 1046 the difference amplifier 1002 has a non-unity gain proportional to the ratio between 1040, 1042 and 1044, 1046.

Resistor 1060 feeds bipolar transistor 1062 to connect resistor 1064 at output 1098 in parallel with a control resistor for a pulse generator circuit, such as the lower resistor in voltage divider 120 of FIG. 2. Resistor 1064 may be a smaller value than that resistor, so that when transistor 1062 is turned on, it will reduce the voltage from the voltage divider (e.g., 120) and reduce the pulse width. Although a bipolar junction transistor is depicted, any appropriate device, switch, etc. can be used including MOSFETs, JFETs, other types of FETs, MODFETs, SiC FETs, GaN FETs, high electron mobility transistors (HEMTs), heterojunction bipolar transistors (HBTs), etc.

FIG. 11 depicts a schematic of a current limiter 1100 having a difference amplifier 1102 that may have a non-unity gain with a reference voltage 1136 in accordance with some embodiments of the invention.

Power supply components may be included but are not shown, such as an AC input, rectifier, and components such as the resistor 712, Zener diode 714 and capacitor 716 of FIG. 7, to which an input of a voltage divider made up of resistors 1126 and 1130 is connected.

The amplifier 1102 compares the voltage from the voltage divider 1126, 1130 with a reference voltage 1136. Amplifier 1102 includes resistors 1140, 1142 and 1144, 1146. If resistors 1144 and 1146 are the same, and resistors 1140 and 1142 are the same, then the op-amp 1150 yields the difference between the inverting and non-inverting inputs. If resistors 1140, 1142 are larger than resistors 1144, 1146 the difference amplifier 1102 has a non-unity gain proportional to the ratio between 1140, 1142 and 1144, 1146.

Resistor 1160 feeds bipolar transistor 1162 to connect resistor 1164 at output 1198 in parallel with a control resistor for a pulse generator circuit, such as the lower resistor in voltage divider 120 of FIG. 2. Resistor 1164 may be a smaller value than that resistor, so that when transistor 1162 is turned on, it will reduce the voltage from the voltage divider (e.g., 120) and reduce the pulse width. Although a bipolar junction transistor is depicted, any appropriate device, switch, etc. can be used including MOSFETs, JFETs, other types of FETs, MODFETs, SiC FETs, GaN FETs, high electron mobility transistors (HEMTs), heterojunction bipolar transistors (HBTs), etc.

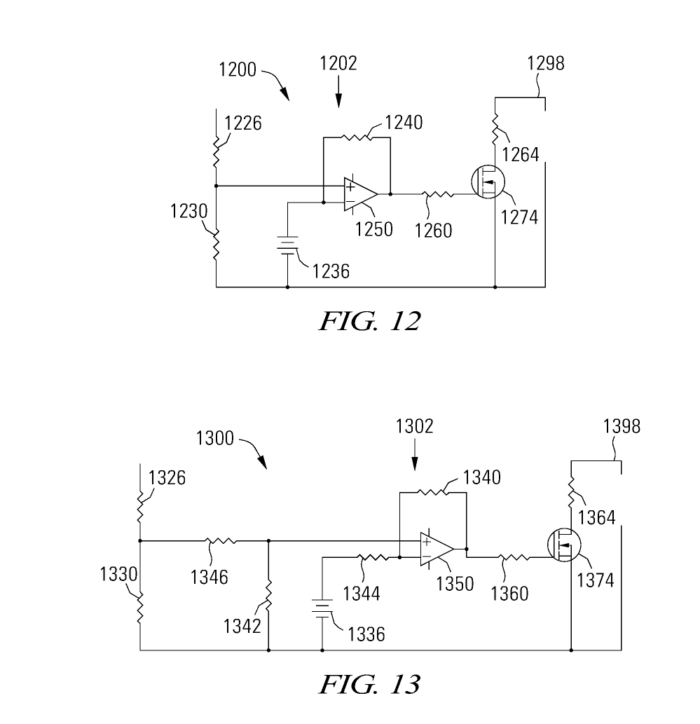

FIG. 12 depicts a schematic of a current limiter 1200 having an error amplifier 1202 or difference amplifier or comparator with a reference voltage 1236 using a field effect transistor 1274 in accordance with some embodiments of the invention.

Power supply components may be included but are not shown, such as an AC input, rectifier, and components such as the resistor 712, Zener diode 714 and capacitor 716 of FIG. 7, to which an input of a voltage divider made up of resistors 1226 and 1230 is connected. The output of the voltage divider of resistors 1226 and 1230 is connected to amplifier 1250, providing the input power monitor to be compared with reference voltage 1236. Feedback resistor 1240 is selected to provide the desired response from amplifier 1250. Resistor 1260 feeds field effect transistor 1274 to connect resistor 1264 at output 1298 in parallel with a control resistor for a pulse generator circuit, such as the lower resistor in voltage divider 120 of FIG. 2. Resistor 1264 may be a smaller value than that resistor, so that when transistor 1274 is turned on, it will reduce the voltage from the voltage divider (e.g., 120) and reduce the pulse width.

FIG. 13 depicts a schematic of a current limiter 1300 having a difference amplifier 1302 that may have a non-unity gain with a reference voltage using a field effect transistor 1374 in accordance with some embodiments of the invention.

Power supply components may be included but are not shown, such as an AC input, rectifier, and components such as the resistor 712, Zener diode 714 and capacitor 716 of FIG. 7, to which an input of a voltage divider made up of resistors 1326 and 1330 is connected.

The amplifier 1302 compares the voltage from the voltage divider 1326, 1330 with a reference voltage 1336. Amplifier 1302 includes resistors 1340, 1342 and 1344, 1346. If resistors 1344 and 1346 are the same, and resistors 1340 and 1342 are the same, then the op-amp 1350 yields the difference between the inverting and non-inverting inputs. If resistors 1340, 1342 are larger than resistors 1344, 1346 the difference amplifier 1302 has a non-unity gain proportional to the ratio between 1340, 1342 and 1344, 1346.

Resistor 1360 feeds field effect transistor 1374 to connect resistor 1364 at output 1398 in parallel with a control resistor for a pulse generator circuit, such as the lower resistor in voltage divider 120 of FIG. 2. Resistor 1364 may be a smaller value than that resistor, so that when transistor 1374 is turned on, it will reduce the voltage from the voltage divider (e.g., 120) and reduce the pulse width.

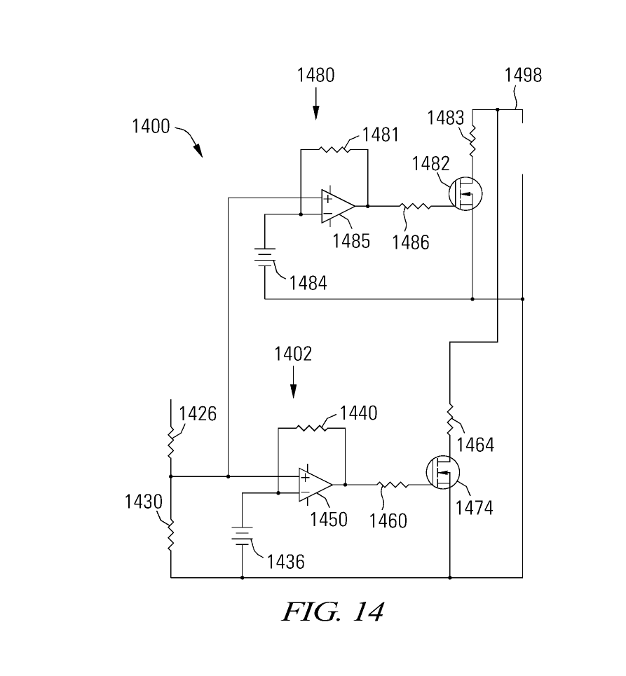

FIG. 14 depicts a schematic of a current limiter 1400 having two error amplifiers 1402 and 1480 or difference amplifiers or comparators with a reference voltage 1436, 1484 in accordance with some embodiments of the invention. In some embodiments, the load current has a gradually increasing slope as the input voltage increases, with the current substantially plateauing within an input voltage range at about the expected operating voltage, thus providing roughly constant current for small voltage fluctuations around the expected operating voltage. If the input voltage measured by the voltage divider in the current limiter exceeds the reference voltage, the load current is limited or reduced, thereby dimming the LED light or other types of loads during overvoltage conditions. In some embodiments of the present invention, the LED light or other types of loads may be turned off or substantially turned off.

In the embodiment of FIG. 14, a current plateau or roughly flat current response can be provided around two possible expected operating voltages, for example at around 80 VAC-130 VAC and at around 200 VAC-240 VAC, using amplifiers 1402 and 1480. Thus the current limiting LED driver can be adapted to operate around the world with different line voltages.

Power supply components may be included but are not shown, such as an AC input, rectifier, and components such as the resistor 712, Zener diode 714 and capacitor 716 of FIG. 7, to which an input of a voltage divider made up of resistors 1426 and 1430 is connected.

The output of the voltage divider of resistors 1426 and 1430 is connected to amplifier 1450, providing the input power monitor/signal to be compared with reference voltage 1436. Feedback resistor 1440 is selected to provide the desired response from amplifier 1450. Resistor 1460 feeds field effect transistor 1474 to connect resistor 1464 at output 1498 in parallel with a control resistor for a pulse generator circuit, such as the lower resistor in voltage divider 140 of FIG. 2. Resistor 1464 may be a smaller value than that resistor, so that when transistor 1474 is turned on, it will reduce the voltage from the voltage divider (e.g., 140) and reduce the pulse width.

The output of the voltage divider of resistors 1426 and 1430 is also connected to a second amplifier 1485, providing the input power monitor to be compared with reference voltage 1484. Feedback resistor 1481 is selected to provide the desired response from amplifier 1485. Resistor 1486 feeds field effect transistor 1482 to connect resistor 1483 at output 1498 in parallel with a control resistor for a pulse generator circuit, such as the lower resistor in voltage divider 140 of FIG. 2.

Of course, various elements of the embodiments disclosed herein may be combined in additional embodiments, for example combining a current limiter as that shown in FIG. 10, having a time constant, replacing the bipolar transistor with a field effect transistor, and including multiple difference amplifiers to accommodate multiple expected operating ranges, just to provide one non-limiting example of another embodiment made up of various elements of pictured embodiments.

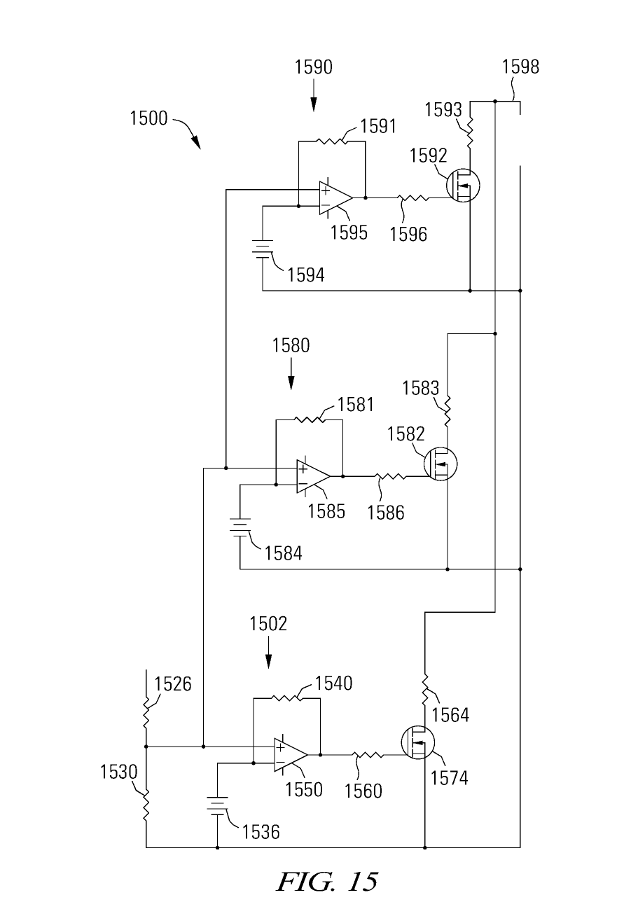

FIG. 15 depicts a schematic of a current limiter 1500 having three error amplifiers 1502, 1580, 1590 or difference amplifiers or comparators with reference voltages 1536, 1584, 1594 in accordance with some embodiments of the invention. This provides a current plateau or roughly flat current response can be provided around three operating voltage ranges and/or a combined relatively flat profile versus input voltage over a meaningful and useful range or ranges of input voltages. The current limiter 1500 may include any desired number of comparator circuits, particularly when embodied in an integrated circuit in which multiplying the comparator circuit does not necessarily multiply the cost or power usage of the device and may reduce cost, power, size, etc.

Power supply components may be included but are not shown, such as an AC input, rectifier, and components such as the resistor 712, Zener diode 714 and capacitor 716 of FIG. 7, to which an input of a voltage divider made up of resistors 1526 and 1530 is connected.

The output of the voltage divider of resistors 1526 and 1530 is connected to amplifier 1550, providing the input power monitor or signal to be compared with reference voltage 1536. Feedback resistor 1540 is selected to provide the desired response from amplifier 1550. Resistor 1560 feeds field effect transistor 1574 to connect resistor 1564 at output 1598 in parallel with a control resistor for a pulse generator circuit, such as the lower resistor in voltage divider 150 of FIG. 2. Resistor 1564 may be a smaller value than that resistor, so that when transistor 1574 is turned on, it will reduce the voltage from the voltage divider (e.g., 150) and reduce the pulse width.

The output of the voltage divider of resistors 1526 and 1530 is also connected to a second amplifier 1585, providing the input power monitor to be compared with reference voltage 1584. Feedback resistor 1581 is selected to provide the desired response from amplifier 1585. Resistor 1586 feeds field effect transistor 1582 to connect resistor 1583 at output 1598 in parallel with a control resistor for a pulse generator circuit, such as the lower resistor in voltage divider 150 of FIG. 2.

The output of the voltage divider of resistors 1526 and 1530 is also connected to a third amplifier 1595, providing the input power monitor to be compared with reference voltage 1594. Feedback resistor 1591 is selected to provide the desired response from amplifier 1595. Resistor 1596 feeds field effect transistor 1592 to connect resistor 1593 at output 1598 in parallel with a control resistor for a pulse generator circuit, such as the lower resistor in voltage divider 150 of FIG. 2.

The above drawings are intended to illustrate the use of N=2 or more control circuits in combination with a shut-off circuit using an op amp or a comparator. Note that the op amps and comparators are connected to an appropriate power source.

The above examples illustrate some possible implementations and are not to be construed as limiting in any way or form. The examples in FIGS. 14 and 15 illustrate implementations of two (or more) of the control circuit. Note that the V2 (V3, etc.) values for each circuit can be different values as well as other circuit components and the V2 can be made of voltage dividers, resistive and/or capacitive networks, etc.

The circuit can share common voltage divider resistors (e.g., 1526, 1530) or have individual ones. There can be capacitor dividers in place of resistors (e.g., 1526, 1530) or capacitors and resistors together to form time constants as well as voltage dividers. There can be any number, N, where N>1 of these circuits, there can be switches to switch in and out various members of the N control circuits. There can be diodes in the circuit so that only the largest or larger output values are fed to Vfb or to, for example, an appropriate scaled voltage, current, signal, etc. There can be a combination of op-amps and comparators. The comparator(s) can be used to completely shut down the circuit above a certain input voltage or in any other fashion for the present invention.

A current monitor (i.e., a sense resistor or winding which can also be used for other purposes) can be used to limit the current or turn off the current, the driver, etc. The sense resistor can, for example, sense current or voltage or power either directly or indirectly. The present invention can be made to provide analog, digital, mixed, pulse width (PWM), duty cycle, etc. combinations of one or more of these, etc. control of the output of the power supply. The present invention can produce a decrease in the current above a certain input voltage, a plateau in the current above a certain voltage, a peak above a certain voltage and can be used to produce more than one/multiple plateaus (i.e., constant current or constant voltage) and/or peaks at certain desired voltage or voltages or ranges of voltages (e.g., 90 to 130 VAC and 200 to 240 VAC, 277 VAC, etc.) or turn off the current, (or voltage, power) etc.

The present invention can be used on power supplies of essentially any type and form including switching power supplies and linear power supplies. Although not explicitly shown here, the same principles, concepts, operations, operating principles, designs, approaches, methods, etc. apply to linear circuits and power supplies, drivers, etc. in which a voltage and/or power or multiple voltages and/or power and/or current monitor and/or signals are fed/connected/inserted at appropriate point(s) in the respective switching and/or linear or combinations of these power supplies, drivers, ballasts, etc to control, limit and/or turn off the output current (or voltage or power) of the respective power supplies, drivers, ballasts, etc. For example, in some embodiments of a linear power supply, the current limiter can be used to turn off the regulating device, such as, but not limited to, a series or parallel regulating device acting as a variable resistor, during overvoltage conditions. The term “regulating device” is thus used herein to refer to the element of the power supply that regulates the output current, such as a switch and pulse generator in a switching power supply, or a Zener diode and series resistor in one type of linear power supply, or error amplifier and transistor in another type of linear power supply, etc. Implementations of the present invention, whether applied to switching or linear or combinations/combined linear/switching power supplies, drivers, ballasts, etc. may be based on one or more of the above control/monitoring signals including, for example, a signal based on the input voltage or a scaled version/representation of the input voltage with other embodiments and implementations of the present invention also using other/additional current limiting information and signals, etc. as well as other methods, approaches, signals, monitoring and control information mentioned elsewhere in this document.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) such as metal oxide semiconductor field effect transistors (MOSFETs) including either p-channel or n-channel MOSFETs, junction field effect transistors (JFETs), metal emitter semiconductor field effect transistors, etc. again, either p-channel or n-channel or both, bipolar junction transistors (BJTs), heterojunction bipolar transistors (HBTs), high electron mobility transistors (HEMTs), unijunction transistors, modulation doped field effect transistors (MODFETs), etc., again, in general, re-channel or p-channel or both, vacuum tubes including diodes, triodes, tetrodes, pentodes, etc. and any other type of switch, etc. The current limiter can used with LED drivers designed for continuous conduction mode (CCM), critical conduction mode (CRM), discontinuous conduction mode (DCM), resonant conduction modes, etc., with any type of circuit topology including but not limited to buck, boost, buck-boost, boost-buck, Cuk, SEPIC, flyback, forward-converters, etc. The present invention works with both isolated and non-isolated designs.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims. The example embodiments are in no way meant or intended to be limiting with the present invention having general and universal applicability well beyond the example embodiments shown herein.

1. A power supply comprising:
a power input;
a load output;
a current regulating device; and
a current limiter operable to cause the current regulating device to limit the flow of current from the power input to the load output during overvoltage conditions at the power input.

2. The power supply of claim 1, wherein the regulating device comprises:
a power control switch operable to control a flow of current from the power input to the load output; and
a pulse generator comprising a pulse output connected to the power control switch and a control input operable to control the pulse output.

3. The power supply of claim 2, further comprising a voltage divider connected to the control input, wherein the current limiter is connected to the voltage divider.

4. The power supply of claim 1, the current limiter comprising an output resistor connected in series with a current limiter switch.

5. The power supply of claim 4, the current limiter comprising a reference voltage source and an amplifier operable to compare a signal derived from the power input with the reference voltage source and to control the current limiter switch based on the comparison.

6. The power supply of claim 5, the current limiter comprising a voltage divider connected to the power input and yielding the signal derived from the power input.

7. The power supply of claim 5, wherein the current limiter switch comprises a transistor.

8. The power supply of claim 1, wherein the current limiter comprises an amplifier operable to compare a signal derived from the power input with the reference voltage source and to control the current regulating device based on the comparison.

9. The power supply of claim 8, further comprising a gain amplifier operable to amplify an output of the amplifier to yield an amplified output to control the current regulating device.

10. The power supply of claim 8, wherein the amplifier comprises a unity gain.

11. The power supply of claim 8, wherein the amplifier comprises a gain greater than unity.

12. The power supply of claim 8, wherein the current limiter applies a time constant to the comparison.

13. The power supply of claim 1, wherein the current limiter comprises two comparison circuits operable to provide plateaus in an output current versus input voltage relationship around two possible expected operating voltages in a current to the load output.

14. The power supply of claim 1, wherein the current limiter comprises a plurality of comparison circuits operable to provide plateaus in an output current versus input voltage relationship around a plurality of operating voltages in a current to the load output.

15. The power supply of claim 2, wherein the pulse generator comprises a variable pulse generator, wherein the pulse output comprises a duty cycle controlled by a voltage at the control input.

16. The power supply of claim 15, wherein the currently limiter is configured to cause a reduction in the voltage at the control input based on overvoltage conditions at the power input.

17. The power supply of claim 2, further comprising:
an inductor connected in series with the load output and the power control switch; and
a tagalong inductor coupled to the inductor, wherein the signal derived from the power input is obtained from the tagalong inductor.

18. The power supply of claim 17, wherein the current limiter is powered by the tagalong inductor.

19. A method of controlling an electrical current, comprising:
generating a pulse stream to control a switch, wherein current flows from a power input to a load output when the switch is closed, and wherein current flows from an energy storage device to the load output when the switch is open; and
comparing a signal derived from the power input with a voltage reference and reducing the pulse stream when the signal derived from the power input is greater than the voltage reference.

20. A current limiting driver circuit, comprising:
a power input;
a load output connected to the power input;
an inductor connected in series with the load output;
a diode connected in parallel with the load output and the inductor;
a switch connected in series with the load output and the inductor, wherein when the switch is open, current flows from the power input to the load output, and wherein the switch is closed, current flows from the inductor to the load output;
a pulse generator connected to a control input of the switch; and
a current limiter connected to the pulse generator and comprising a comparator operable to compare a signal derived from the power input with a voltage reference and to limit an output of the pulse generator when the signal derived from the power input exceeds the voltage reference.
